(19) United States
(12) Patent Application Publication
(10) Pub. No.: US 2009/0051355 A1
(43) Pub. Date: Feb. 26, 2009

(54) Proximity sensor and proximity detection method

(75) Inventor: Kazuhiro Yamakawa, Saitama (JP)

Correspondence Address: OLIFF & BERRIDGE, PLC, P.O. BOX 320850, ALEXANDRIA, VA, 22320-4850, US

(73) Assignee: AZUMA SYSTEMS CO., LTD, Kumagaya-shi, Saitama (JP)

(21) Appl. No.: 11/991,156

(22) PCT Filed: Aug. 31, 2006
(86) PCT No.: PCT/JP2006/317175

§ 371 Date: Feb. 28, 2008

(30) Foreign Application Priority Data
Sep. 2, 2005 (JP) 2005-254482
Aug. 29, 2006 (JP) 2006-232267
Aug. 29, 2006 (JP) 2006-232268

(51) Int. Cl. G01B 7/00

(52) U.S. Cl. 324/207.26

(57) ABSTRACT

A proximity sensor for detecting proximity of a metal, wherein a driving signal is output to a resonant circuit that includes a capacitor connected to a detecting coil, and the proximity of the metal is detected based on a phase shift of freely oscillating waves that are attenuatedly output from the resonant circuit after an output of the driving signal is stopped, the proximity sensor includes a controller that outputs the driving signal to the resonant circuit; and measures a phase shift of oscillating waves that is involved in the proximity of the metal based on the freely oscillating waves that are attenuatedly output from the resonant circuit after the output of the driving signal is stopped.

### CROSS-REFERENCE TO RELATED APPLICATIONS

This application is the U.S. National Stage of PCT/JP2006/317175, filed Aug. 31, 2006, which claims priority from JP2005-254482, filed Sep. 2, 2005, JP2006-232267, filed Aug. 29, 2006, and JP2006-232268, filed Aug. 29, 2006, the entire disclosures of which are incorporated herein by reference hereto.

### BACKGROUND

The present disclosure relates to a proximity sensor and a proximity detecting method.

A proximity sensor that detects proximity of a metal has been widely used (see Japanese Patent No. 2550621, for example). The proximity sensor of this kind includes not only a proximity switch that is used as a non-contact micro switch but also a displacement sensor that detects a displacement of a metal, a distance sensor that detects a proximity distance to a metal, a material sensor that determines a material of a metal, a coin sensor that detects a passage of a coin (hard currency, a token, and the like), and a metallic sphere sensor that detects a penetration of a metallic sphere (a pachinko ball and the like).

The proximity sensor of Japanese Patent No. 2550621 is a high frequency oscillation type proximity switch that is provided with a high frequency oscillation circuit that includes a detecting coil. The proximity sensor determines a proximity or material of a metal, taking advantage of the fact that an oscillation amplitude or oscillation frequency of the high frequency oscillation circuit varies when a metal is proximate to the detecting coil. More specifically, the oscillation amplitude or oscillation frequency of the high frequency oscillation circuit varies according to not only a proximity distance to the metal but also properties of a material of the metal (differences in magnetic permeability, electric conductivity, and the like). A proximity switch in a manner of measuring amplitude can well detect proximity of a magnetic metal (iron and the like). A proximity sensor in a manner of measuring a frequency can well detect proximity of a non-magnetic metal (aluminum and the like). A proximity sensor that has a function for both manners above can well detect proximity of a magnetic metal and a non-magnetic metal, and also well determine a material of a metal.

### SUMMARY

In measuring a frequency change according to proximity of a metal and maintaining a high frequency oscillation; however, the conventional proximity sensor in the manner of measuring a frequency measures a subtle phase shift. A complicated circuit such as a synchronous detection circuit is thus required, which leads to a problem in that the proximity sensor can be remarkably expensive as compared with a proximity sensor in the manner of measuring amplitude. Although the subtle phase shift can be detected by a digital circuit, an exceedingly high-speed counter or CPU is required. Consequently, the cost may become even higher. The present disclosure solves these problems as well as other problems and is also able to achieve various advantages.

The disclosure addresses an exemplary aspect, in which a proximity sensor detects proximity of a metal, wherein a driving signal is output to a resonant circuit that includes a capacitor connected to a detecting coil, and the proximity of the metal is detected based on a phase shift of freely oscillating waves that are attenuatedly output from the resonant circuit after an output of the driving signal is stopped, the proximity sensor includes a controller that: outputs the driving signal to the resonant circuit; and measures a phase shift of oscillating waves that is involved in the proximity of the metal based on the freely oscillating waves that are attenuatedly output from the resonant circuit after the output of the driving signal is stopped. According to the proximity sensor, the phase shift of the oscillating waves that is involved in the proximity of the metal can be measured accurately with a simple circuit configuration. More specifically, the phase shift of the oscillating waves that is involved in the proximity of the metal occurs clearly as for freely oscillating waves that are attenuatedly output from the resonant circuit. Moreover, the phase shift in the freely oscillating waves is accumulated by the number of oscillating waves. As a result, the phase shift can be measured with high accuracy even by an inexpensive circuit.

In another exemplary aspect, the controller: counts a number of the freely oscillating waves that are attenuatedly output from the resonant circuit after the output of the driving signal is stopped; and counts a time until a predetermined number of the freely oscillating waves are counted. According to the proximity sensor, the accumulated phase shift can be measured with high accuracy by an inexpensive digital circuit.

In another exemplary aspect, the controller repeats a predetermined number of times a regression operation of counting a number of the freely oscillating waves that are output from the resonant circuit after the output of the driving signal is stopped, and outputting the driving signal at a time of counting a predetermined number of the freely oscillating waves, so that the phase shift of the freely oscillating waves is amplified. According to the proximity sensor, measurement accuracy of the phase shift that is involved in the proximity of the metal can significantly be improved only by increasing the number of times of the regression operation, without rendering the circuit configuration complicated.

In another exemplary aspect, the controller: repeats a predetermined number of times a regression operation of counting a number of the freely oscillating waves that are output from the resonant circuit after the output of the driving signal is stopped, and outputting the driving signal at a time of counting the predetermined number of the freely oscillating waves, so that the phase shift of the freely oscillating waves is amplified; starts clocking in response to a first output of the driving signal; and finishes clocking when a predetermined number of the freely oscillating waves is output from the resonant circuit after the regression operation is finished the predetermined number of times. According to the proximity sensor, the amplified phase shift can be measured with high accuracy by an inexpensive digital circuit.

In another exemplary aspect, a proximity detecting method for detecting proximity of a metal includes outputting a driving signal to a resonant circuit that includes a capacitor connected to a detecting coil; and detecting the proximity of the metal based on a phase shift of freely oscillating waves that are attenuatedly output from the resonant circuit after the output of the driving signal is stopped. According to the proximity detecting method, the phase shift of the oscillating waves that is involved in the proximity of the metal can be measured accurately with a simple circuit configuration. More specifically, the phase shift of oscillating waves that is involved in the proximity of the metal occurs clearly as for freely oscillating waves that are attenuatedly output from the resonant circuit. Moreover, the phase shift in the freely oscillating waves is accumulated by the number of oscillating waves. As a result, the phase shift can be measured with high accuracy by an inexpensive circuit.

In another exemplary aspect, the proximity detecting method further includes outputting the driving signal to the resonant circuit; counting a number of the freely oscillating waves that are attenuatedly output from the resonant circuit after the output of the driving signal is stopped; measuring a time until a predetermined number of the freely oscillating waves is counted; and measuring the phase shift of the oscillating waves that is involved in the proximity of the metal based on the measured time. According to the proximity detecting method, the accumulated phase shift can be measured with high accuracy by an inexpensive digital circuit.

In another exemplary aspect, a proximity detecting method for detecting proximity of a metal includes outputting a driving signal to a resonant circuit that includes a capacitor connected to a detecting coil; measuring a phase shift of oscillating waves that is involved in the proximity of the metal based on freely oscillating waves that are attenuatedly output from the resonant circuit after the output of the driving signal is stopped; and repeating a predetermined number of times a regression operation of counting a number of the freely oscillating waves that are output from the resonant circuit after the output of the driving signal is stopped, and outputting the driving signal to the resonant circuit at a time of counting a predetermined number of the freely oscillating waves, so that the phase shift of the freely oscillating waves is amplified. According to the proximity detecting method, measurement accuracy of the phase shift that is involved in the proximity of the metal can be significantly improved only by increasing the number of times of the regression operation, without rendering the circuit configuration complicated.

In another exemplary aspect, the proximity detecting method further includes starting clocking in response to a first output of the driving signal to the resonant circuit; finishing clocking when the predetermined number of the freely oscillating waves is output from the resonant circuit after the regression operation is finished the predetermined number of times; and measuring the phase shift of the oscillating waves that is involved in the proximity of the metal based on a result of the clocking.

According to the proximity detecting method, the amplified phase shift can be measured with high accuracy by an inexpensive digital circuit.

According to the present disclosure, as above, the phase shift of oscillating waves that is involved in the proximity of the metal can be measured accurately with a simple circuit configuration. More specifically, as for freely oscillating waves that are attenuatedly output from the resonant circuit, the phase shift of oscillating waves that is involved in the proximity of the metal occurs clearly. Moreover, the phase shift in the freely oscillating waves is accumulated by the number of oscillating waves. As a result, the phase shift can be measured with high accuracy even by an inexpensive circuit.

### BRIEF DESCRIPTION OF THE DRAWINGS

Various embodiments of the present disclosure will be described with reference to the drawings, wherein:

FIG. 1 is a block diagram showing a configuration of a proximity sensor in accordance with a first embodiment of the present disclosure;

FIG. 2 is a flow chart showing a processing procedure of a one-chip microcomputer in accordance with the first embodiment of the present disclosure;

FIG. 3 is an explanatory diagram showing a waveform of a driving pulse signal (Point a) and an oscillating waveform of a resonant circuit (Point b) in accordance with the first embodiment of the present disclosure;

FIG. 4 is an explanatory diagram showing, in an enlarged manner, a tenth-odd freely oscillating wave in accordance with the first embodiment of the present disclosure;

FIG. 5 is an explanatory diagram showing a phase shift when a metal is in proximity (7 millimeters) to a detecting coil in accordance with the first embodiment of the present disclosure;

FIG. 6 is an explanatory diagram showing a phase shift when the metal is in proximity (3 millimeters) to the detecting coil in accordance with the first embodiment of the present disclosure;

FIG. 7 is an explanatory diagram showing a relationship between a freely oscillating waveform (Point b) and an output of a comparator (Point c) in accordance with the first embodiment of the present disclosure;

FIG. 8 is an enlarged view showing an output of the comparator when the metal is not in proximity to the detecting coil in accordance with the first embodiment of the present disclosure;

FIG. 9 is an explanatory diagram showing an output of the comparator when the metal is in proximity (7 millimeters) to the detecting coil in accordance with the first embodiment of the present disclosure;

FIG. 10 is an explanatory diagram showing an output of the comparator when the metal is in proximity (3 millimeters) to the detecting coil in accordance with the first embodiment of the present disclosure.

FIG. 11 is a graph showing a relationship between proximity distance to the metal and a phase shift in accordance with the first embodiment of the present disclosure;

FIG. 12 is an explanatory diagram showing an action of amplifying the phase shift by a regression operation in accordance with a second embodiment of the present disclosure; and

FIG. 13 is a flow chart showing a processing procedure of a one-chip microcomputer in accordance with the second embodiment of the present disclosure.

### DETAILED DESCRIPTION OF EMBODIMENTS

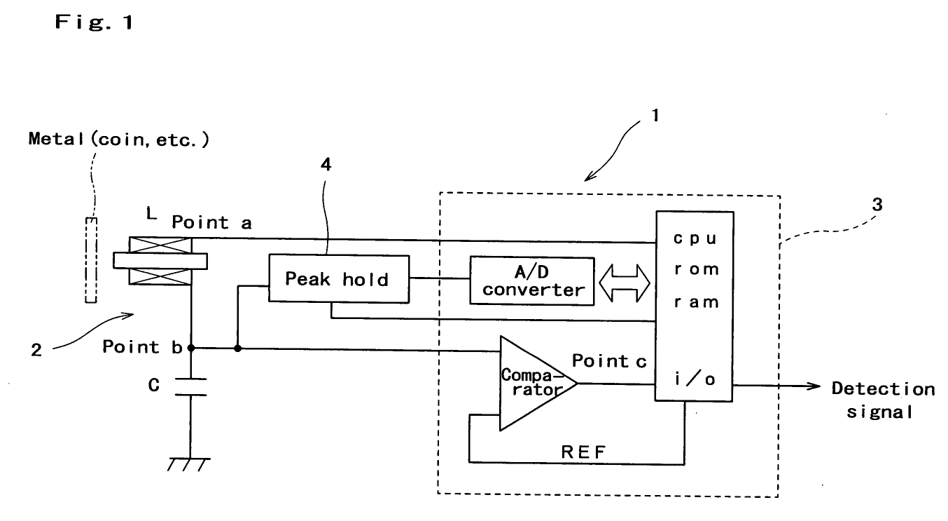

Next, a first embodiment of the present disclosure is described based on the drawings. Numeral 1 shown in FIG. 1 is a proximity sensor that detects proximity of a metal. The proximity sensor 1 includes a resonant circuit 2, a one-chip microcomputer 3, and a peak hold 4 (see FIG. 1). The resonant circuit 2 includes a capacitor C connected to a detecting coil L and is driven by a driving signal outputting device that is configured within the one-chip microcomputer 3. The one-chip microcomputer 3, which is an example of a controller, houses a central processing unit (CPU), a read-only memory (ROM), a random access memory (RAM), an input/output device (I/O), a comparator, an analog to digital (A/D) converter, and the like. The one-chip microcomputer 3 operates as a driving signal outputting device, a phase shift measuring device, and an amplitude measuring device by writing a predetermined processing procedure (program) on the ROM.

The phase shift measuring device is configured so to measure a phase shift of oscillating waves that is involved in the proximity of a metal based on freely oscillating waves that are attenuatedly output from the resonant circuit 2 after the driving signal outputting device stops its signal output. The phase shift of the oscillating waves that is involved in the proximity of the metal thus can be measured accurately with a simple circuit configuration. More specifically, as for the freely oscillating waves that are attenuatedly output from the resonant circuit 2, not only does the phase shift of the oscillating waves that is involved in the proximity of the metal occur clearly, but the phase shift is also accumulated by the number of the oscillating waves. The phase shift can thus be measured with high accuracy with an inexpensive digital circuit that does not have a high speed counter. Moreover, because of the detecting manner of this kind, the detecting coil L can be used as an exciting coil as well. Accordingly, the number of coils is reduced so that a further cost reduction can be accomplished.

In the first embodiment, the phase shift measuring device includes a freely oscillating wave counting device that counts the number of freely oscillating waves that are attenuatedly output from the resonant circuit 2 after the driving signal outputting device stops its signal output, and a counting time measuring device that measures a time until the freely oscillating wave counting device counts a predetermined number n of freely oscillating waves. The accumulated phase shift thus can be measured with high accuracy by an inexpensive digital circuit. While preferably being set to 2 to 100, the number n of freely oscillating waves counted can be set optionally according to required measurement accuracy and performance (price) of a coil. The proximity sensor 1 with high cost performance thus can be provided. For example, when price is given priority, an inexpensive coil can be used that is larger in attenuation of a freely oscillating wave, and the number n of freely oscillating waves counted can be set to about 2 to 10. When accuracy is given priority, an expensive coil can be used that is smaller in attenuation of a freely oscillating wave, and the number n of freely oscillating waves counted can be set to about 10 to 100.

The resonant circuit 2 is preferably a series resonant circuit in which the capacitor C is serially connected to the detecting coil L. A voltage Q times (8 times, for example) as large as a source voltage (5V, for example) at the maximum thus can be applied to the detecting coil L by the action of the series resonant circuit. Consequently, a freely oscillating wave of a large amplitude can be output from the resonant circuit 2. The number n of freely oscillating waves counted can be increased so that not only is measurement accuracy further enhanced but also resistance to noise is improved. Because freely oscillating waves of a large amplitude can be directly input to the one-chip microcomputer 3 (the phase shift measuring device) without an amplifier, the circuit configuration is simpler, which makes a further cost reduction possible.

The maximum voltage VLMAX that is applied to the detecting coil L can be obtained by the following equation, Formula 1, wherein: ω0 represents a resonant angular frequency; L represents an inductance of the detecting coil L; R represents a resistance of the detecting coil L; C represents a capacitance of the capacitor C; VS represents a source voltage; and Q represents a quality factor of the resonant circuit.

$${ω}_{0} = \frac{1}{\sqrt{L C}} \\ Q = \frac{{ω}_{0} L}{R} \\ {V}_{LMAX} = Q \cdot Vs \qquad Formula 1$$

When the resonant circuit 2 is forcedly oscillated by a driving pulse signal, the driving signal outputting device of the first embodiment forcedly oscillates the resonant circuit 2 by a plurality of driving pulse signals and then stops outputting the driving signals. An amplitude of a forcedly oscillating wave thus can be larger compared to the case when the resonant circuit 2 is forcedly oscillated by a single shot driving pulse signal. In particular, if several shots (6 shots, for example) of the driving pulse signals are output at a predetermined resonant frequency such that the amplitude of the forcedly oscillating wave is maximized, an amplitude of a freely oscillating wave that is output from the resonant circuit 2 after the driving signals are stopped being output can be larger, whereupon measurement accuracy can be further enhanced.

A resonant frequency f at which the resonant circuit 2 is forcedly oscillated can be obtained by the following equation, Formula 2, wherein: L represents an inductance of the detecting coil L; and C represents a capacitance of the capacitor C.

$$f = \frac{1}{2 π \sqrt{L C}} \qquad Formula 2$$

The amplitude measuring device measures amplitude of a freely oscillating wave that is output from the resonant circuit 2. More specifically, into the one-chip microcomputer 3 via the A/D converter, the amplitude measuring device reads a peak value that has been held by the peak hold 4. Amplitude and a phase shift of the freely oscillating waves thus can be measured. A material of a metal can also be determined with high accuracy.

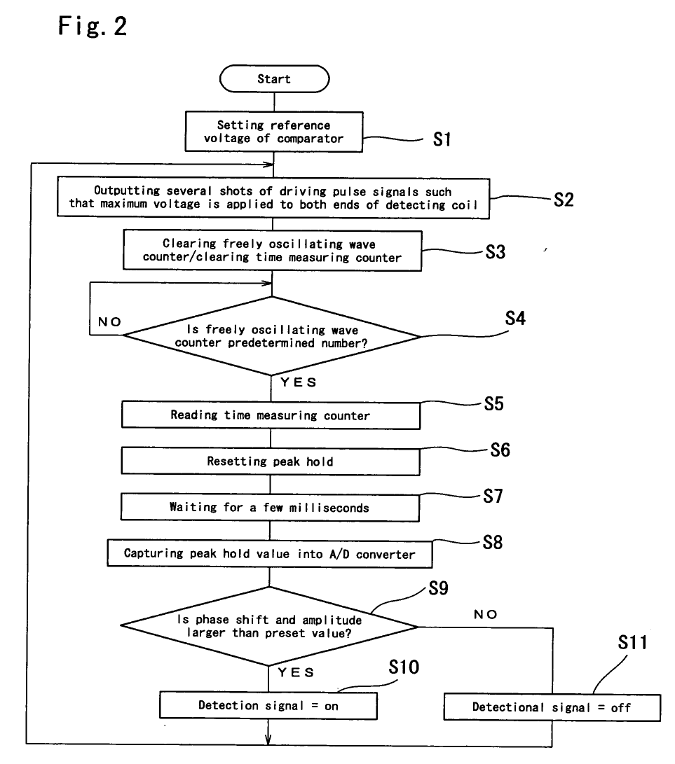

Next, a processing procedure on the one-chip microcomputer 3 is described with reference to FIG. 2. The one-chip microcomputer 3 first sets a reference voltage of the comparator (S1). After that, the one-chip microcomputer 3 repeats driving signal outputting processing (S2: the driving signal outputting device), phase shift measuring processing (S3 to S5: the phase shift measuring device), amplitude measuring processing (S6 to S8: the amplitude measuring device), and proximity determining processing (S9 to S11).

The driving signal outputting processing outputs several shots of driving pulse signals at a predetermined resonant frequency with respect to the resonant circuit 2 so that the amplitude of the forcedly oscillating wave can be maximized. After the driving signals are stopped being output, the phase shift measuring processing clears a freely oscillating wave counter and a time measuring counter. Counting the number of freely oscillating waves that are attenuatedly output from the resonant circuit 2, the phase shift measuring processing measures a time until the freely oscillating wave counter reaches to the predetermined number n. After the predetermined number n of freely oscillating waves is counted, the amplitude measuring processing resets the peak hold 4, waits for a predetermined time (a few milliseconds), and reads in a peak hold value (a measured amplitude value) via the A/D converter. The proximity determining processing compares both the measured phase shift (value of the time measuring counter) and the measured amplitude (peak hold value) with a preset intended determination value, and thereafter outputs a detection signal (ON/OFF).

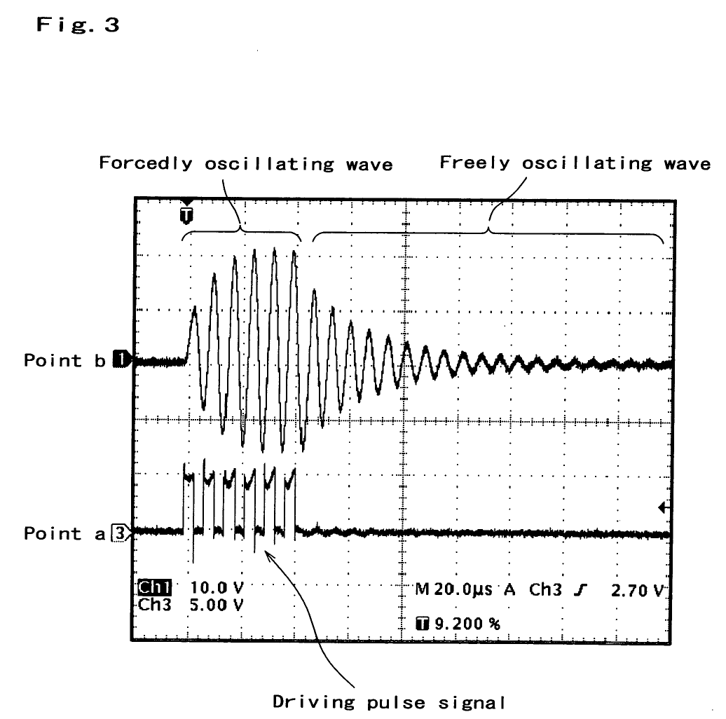

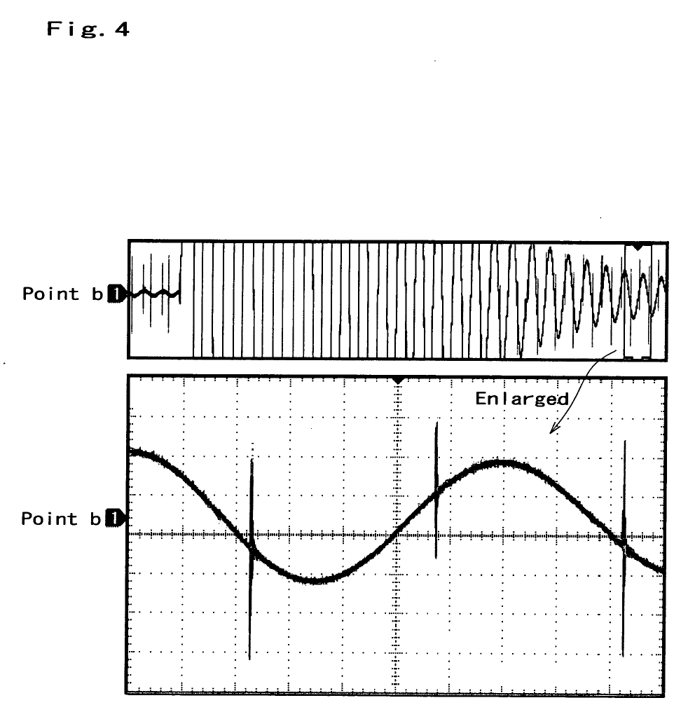

Next, operation of the proximity sensor 1 of the first embodiment is described with reference to FIGS. 3 to 11. FIG. 3 is an explanatory diagram that shows a waveform of the driving pulse signal (Point a) and an oscillating waveform of the resonant circuit (Point b). The one-chip microcomputer 3 outputs a driving pulse signal at a predetermined voltage (5V, for example) in order to forcedly oscillate the resonant circuit 2 (see FIG. 3). At this time, in the first embodiment, because several shots (6 shots, for example) of the driving pulse signals are output at a predetermined resonant frequency, the maximum voltage (40V, for example) is applied to the detecting coil L. After the driving pulse signals are stopped being output, a plurality of freely oscillating waves are attenuatedly output from the resonant circuit 2.

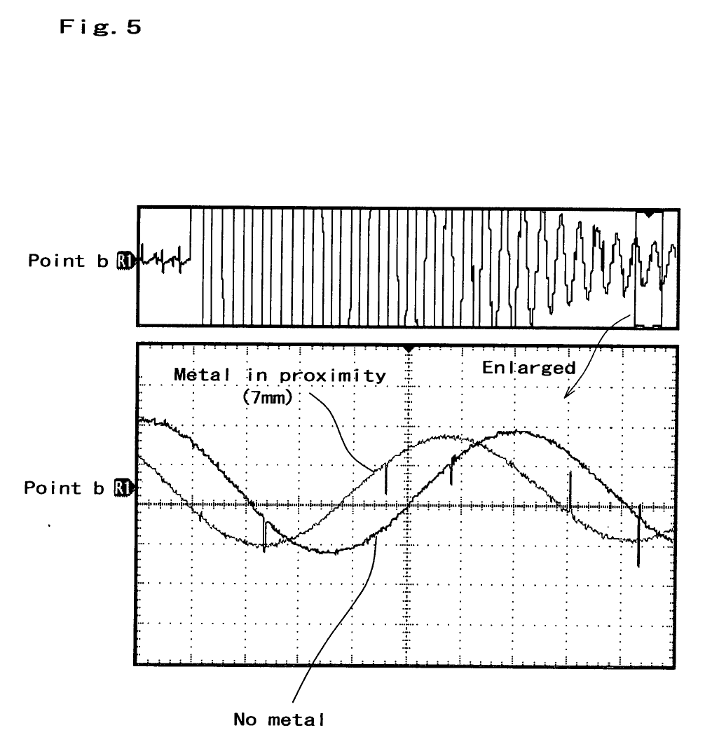

As shown in FIGS. 4, 5, and 6, the freely oscillating wave that is output from the resonant circuit 2, even if being a tenth-odd, maintains sufficient amplitude in order to be detected even. When a metal (a coin: a non-magnetic metal) becomes proximate to the detecting coil L, a magnetic flux that is generated from the detecting coil L magnetically interferes with the metal in proximity. Then a phase of the freely oscillating waves is advanced. The phase shift of the freely oscillating waves that is involved in the proximity of the metal not only occurs more clearly as compared with that of forcedly oscillating waves, but is also accumulated by the number of freely oscillating waves. The phase shift thus can be measured with high accuracy even by a low speed counter.

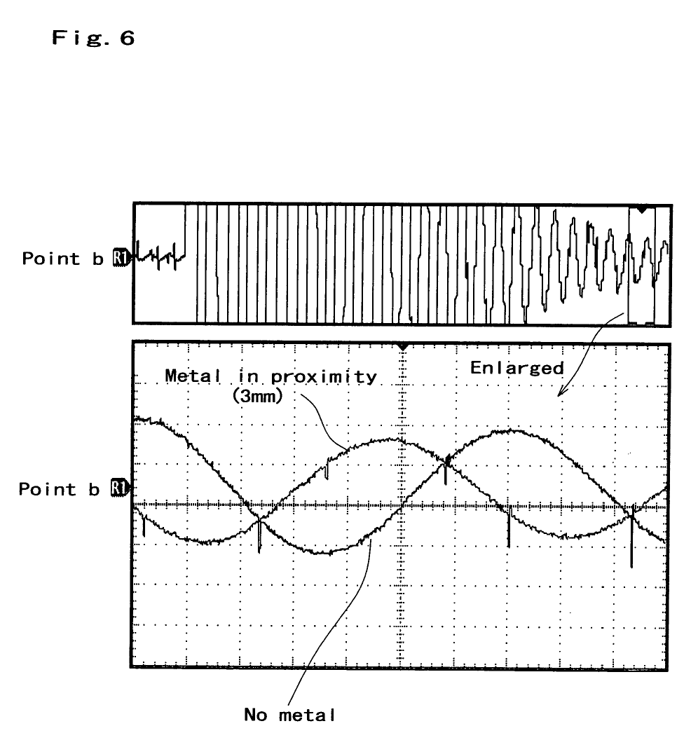

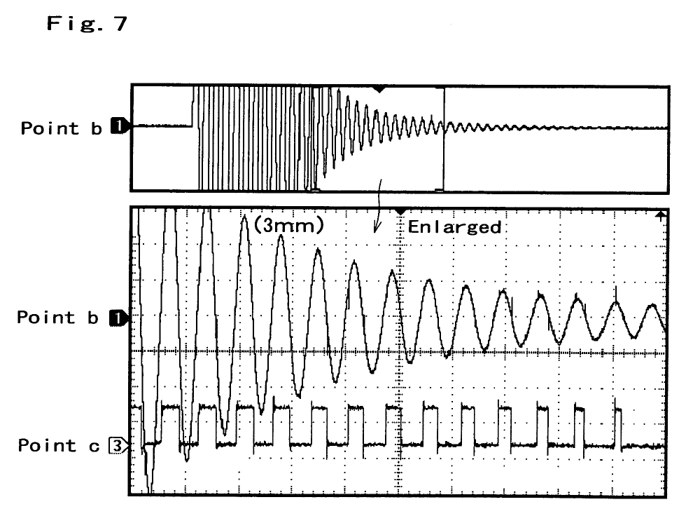

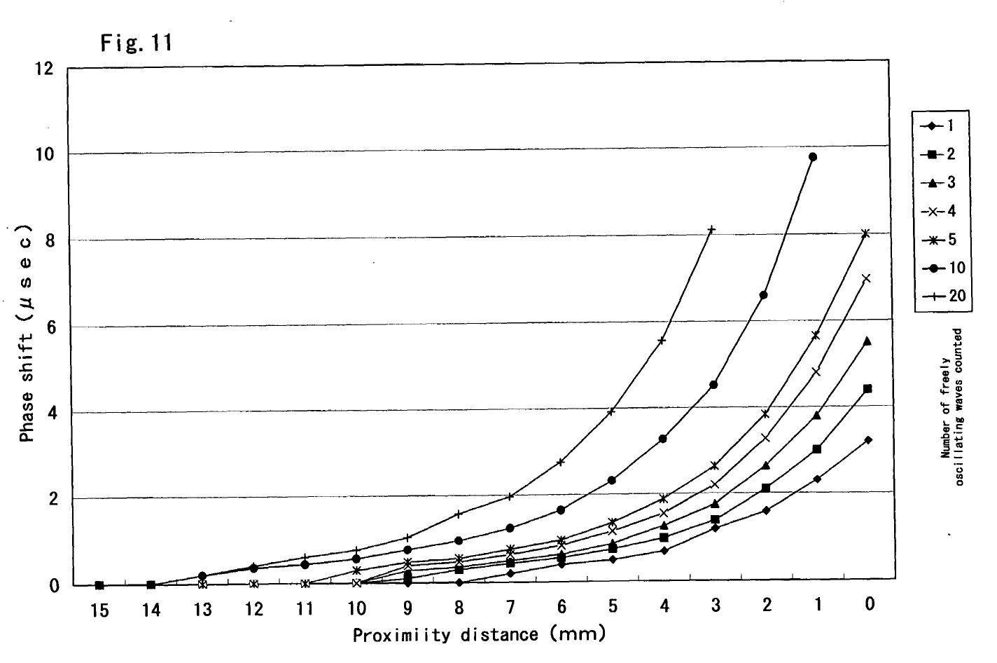

As shown in FIGS. 5 and 6, the phase shift of the freely oscillating waves becomes larger as the metal is closer to the detecting coil L. A distance between the detecting coil L and the metal can be measured with high accuracy based on the phase shift of the freely oscillating waves. FIG. 11 illustrates a relationship between a proximity distance to the metal (mm) and the phase shift (μsec). The phase shift of the freely oscillating waves becomes larger as the metal is closer to the detecting coil L. In particular, the phase shift is added by 10 to 20 times in data of the phase shift of the tenth to twentieth freely oscillating waves. A distance measurement (a displacement measurement) with exceedingly high accuracy is thus achieved.

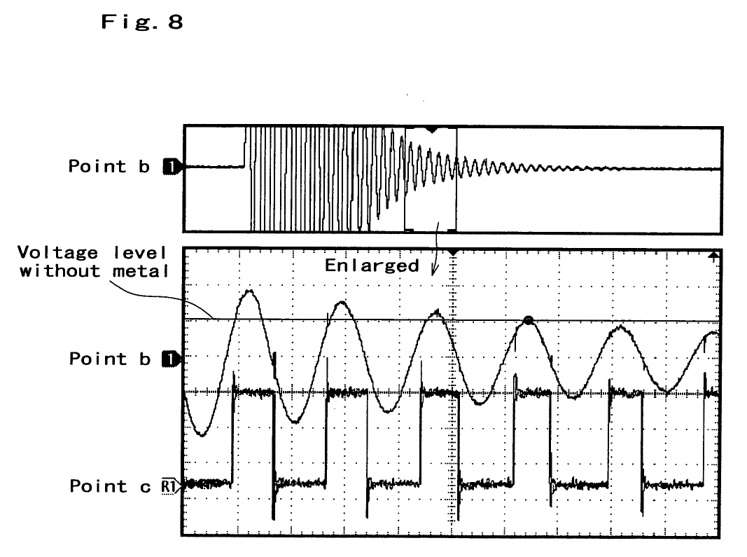

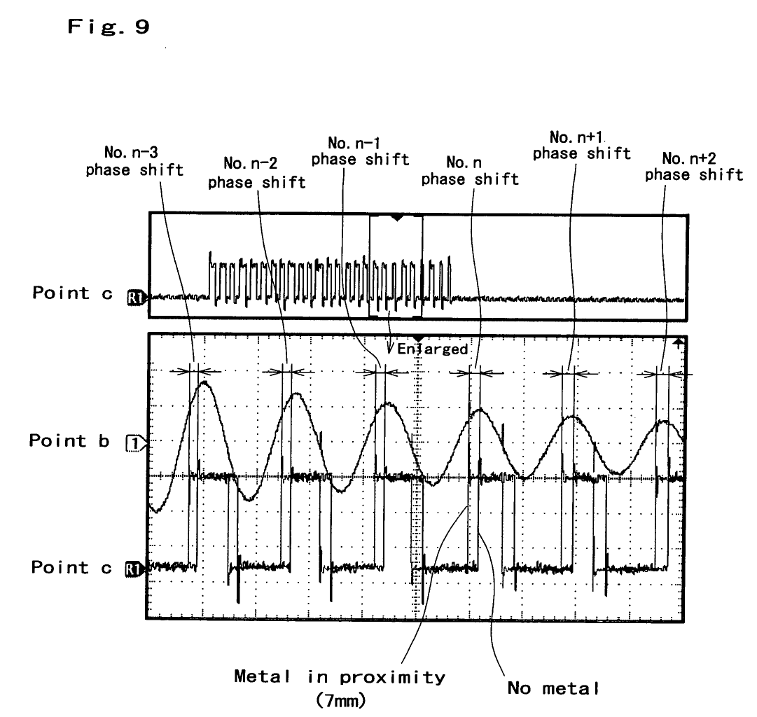

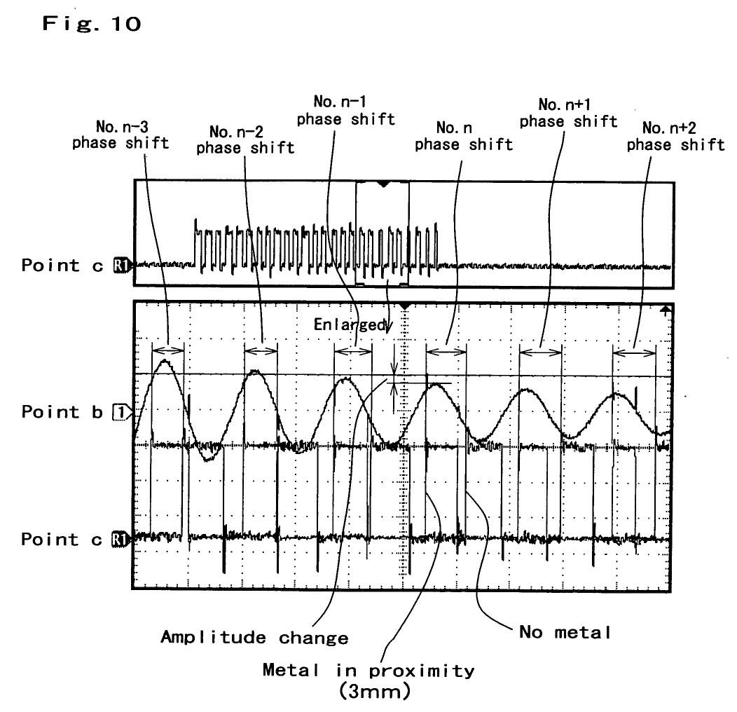

As shown in FIGS. 7 to 10, the freely oscillating wave that is output from the resonant circuit 2 maintains sufficient amplitude in order to be detected, even if being a tenth-odd. The wave thus can be transformed into a clear rectangular wave by the comparator. When a metal becomes proximate to the detecting coil L, a phase of the output waveform of the comparator is advanced. As is obvious from FIGS. 9 and 10, the phase shift that is involved in the proximity of the metal is more accumulated as the number of freely oscillating waves is increased, so that measurement is facilitated.

As shown in FIGS. 8, 9, and 10, the amplitude of the freely oscillating wave varies with the proximity of the metal. By measuring this amplitude change, the proximity of the metal is doubly detected. Not only can a more reliable proximity determination be possible, but a material determination of the metal can also be made based on combination patterns of the phase shift and the amplitude change.

The proximity sensor 1 of the first embodiment configured as above includes a resonant circuit 2 that includes a capacitor C connected to a detecting coil L, a driving signal outputting device that outputs a driving signal with respect to the resonant circuit 2, and a phase shift measuring device that measures a phase shift of oscillating waves that is involved in a proximity of a metal based on freely oscillating waves that are attenuatedly output from the resonant circuit 2 after the driving signal outputting device stops its signal output. Therefore, the phase shift of the oscillating waves that is involved in the proximity of the metal can be measured accurately with a simple circuit configuration. That is, in terms of freely oscillating waves that are attenuatedly output from the resonant circuit 2, the phase shift of the oscillating waves that is involved in the proximity of the metal occurs clearly, and also is accumulated by the number of oscillating waves. Therefore, the phase shift can be measured with high accuracy even by an inexpensive digital circuit without a high speed counter.

According to the detecting manner of this kind, the detecting coil L can be also used as an exciting coil. The number of coils is thus reduced such that a further cost reduction can be accomplished.

Furthermore the phase shift measuring device includes a freely oscillating wave counting device that counts the number of freely oscillating waves that are attenuatedly output from the resonant circuit 2 after the driving signal outputting device stops its signal output and a counting time measuring device that measures a time until the freely oscillating wave counting device counts a predetermined number n of freely oscillating waves. Therefore, the accumulated phase shift can be measured with high accuracy by an inexpensive digital circuit.

The number n of freely oscillating waves counted is set within 2 to 100 and also can be set optionally based on required measurement accuracy and performance (price) of a coil. If price is given preference, for example, an inexpensive coil can be used that is larger in attenuation of a freely oscillating wave. The number n of freely oscillating waves counted can be set to about 2 to 10. If accuracy is given preference, an expensive coil can be used that is smaller in attenuation of a freely oscillating wave. The number n of freely oscillating waves counted can be set to about 10 to 100. The proximity sensor 1 with high cost performance can be provided.

The resonant circuit 2 is a series resonant circuit that includes the capacitor C connected to the detecting coil L. Because a voltage Q times as large as a source voltage at the maximum can be applied to the detecting coil L by the action of the series resonant circuit, a freely oscillating wave of a large amplitude can be output from the resonant circuit 2. The number n of freely oscillating waves counted can be increased. Measurement accuracy is further enhanced and resistance to noise is improved.

The driving signal outputting device forcedly oscillates the resonant circuit 2 by a plurality of driving pulse signals, and then stops outputting the driving signals. An amplitude of a forcedly oscillating wave can be larger compared to the case when the resonant circuit 2 is forcedly oscillated by a single shot driving pulse signal. If several shots of driving pulse signals are output such that the amplitude of the forcedly oscillating wave is maximized, then a large amplitude of a freely oscillating wave can be output from the resonant circuit 2 after the driving signals are stopped being output. The measurement accuracy can be further enhanced.

Because the phase shift measuring device directly inputs an output signal of the resonant circuit 2 without being via an amplifier, the circuit configuration can be simpler. A further cost reduction can be possible.

Because both the driving signal outputting device and the phase shift measuring device are arranged into the one-chip microcomputer 3, the proximity sensor 1 with high performance can include only the resonant circuit 2 (the detecting coil L and the capacitor C) and the one-chip microcomputer 3.

Because the amplitude measuring device that measures an amplitude of a freely oscillating wave that is output from the resonant circuit 2 is provided, a material of a metal can also be determined with high accuracy based on the amplitude and the phase shift of freely oscillating waves.

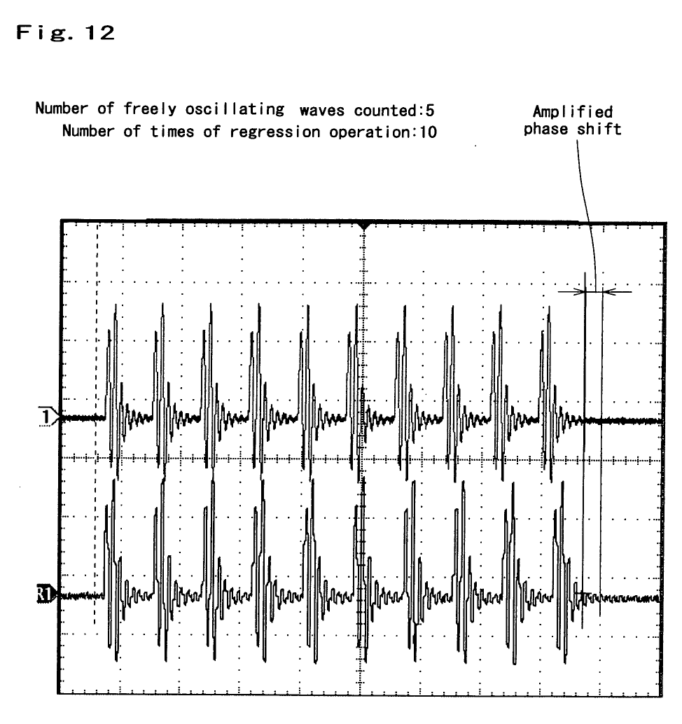

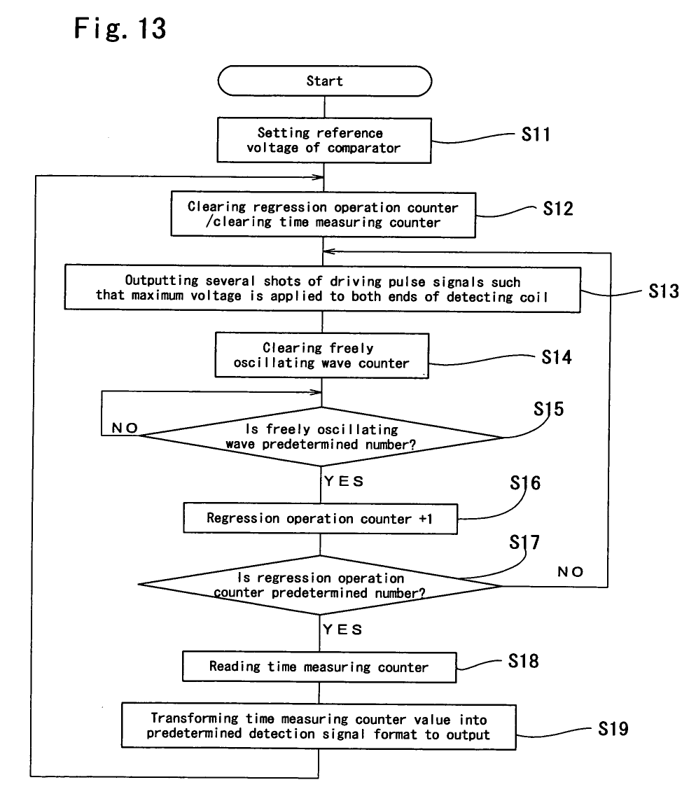

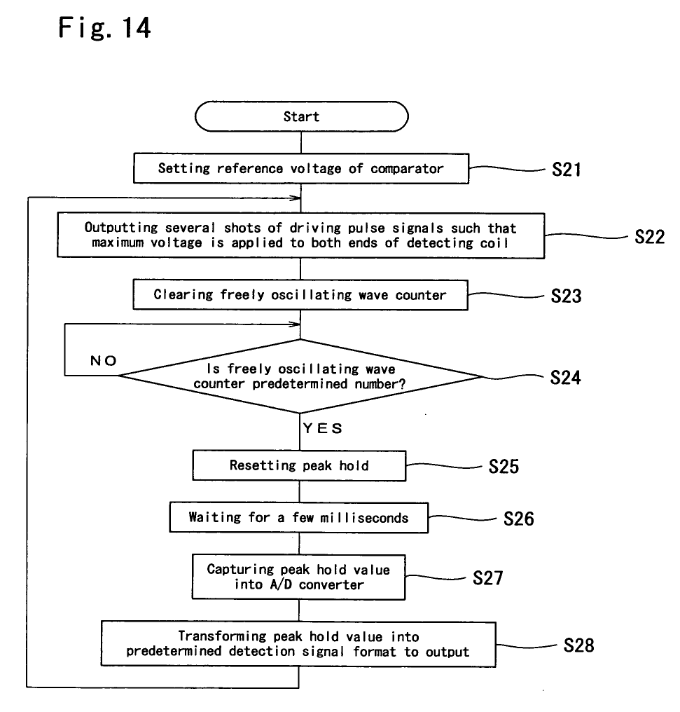

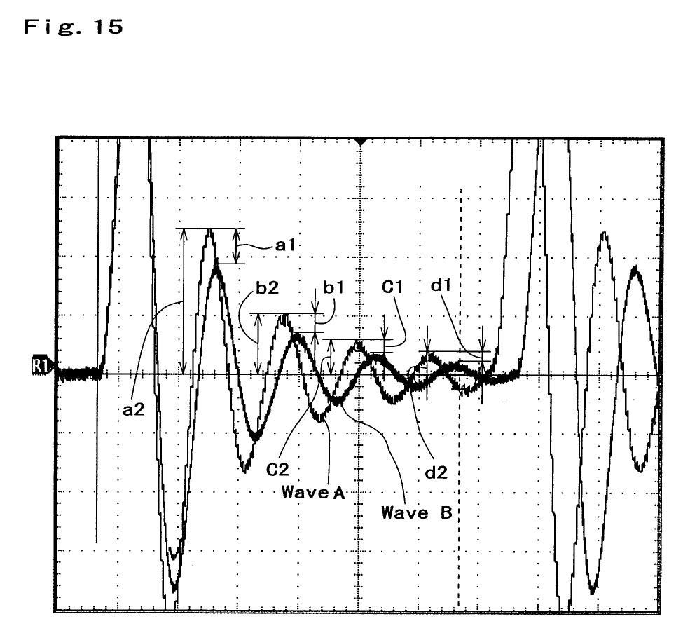

Next, a proximity sensor 1 of a second embodiment of the present disclosure is described with reference to FIGS. 12 and 13. The proximity sensor 1 of the second embodiment differs from that of the first embodiment in that a phase shift of freely oscillating waves is amplified by repeating a regression operation a predetermined number of times in order to measure the phase shift of oscillating waves that is involved in the proximity of a metal based on freely oscillating waves that are attenuatedly output from the resonant circuit 2 after a signal output to the resonant circuit 2 is stopped. The regression operation counts the number of freely oscillating waves that are output from the resonant circuit 2 after the signal output to the resonant circuit 2 is stopped, and then outputs a driving signal to the resonant circuit 2 at the time of counting a predetermined number of freely oscillating waves.

By this device, measurement accuracy of the phase shift that is involved in the proximity of the metal can be significantly improved only by increasing the number of regression operations, without rendering the circuit configuration complicated. For example, the phase shift measuring device includes a time measuring device that starts clocking in response to a first output of driving signals of the driving signal outputting device and finishes clocking at the moment when a predetermined number of freely oscillating waves are output from the resonant circuit 2 after the predetermined number of times of the regression operation is finished. The amplified phase shift thus can be measured with high accuracy with an inexpensive digital circuit.

The number of freely oscillating waves counted and the number of times the regression operation can be set optionally according to required measurement accuracy and performance (price) of a coil. When cost performance is given priority, for example, a relatively inexpensive coil can be used that is larger in attenuation of a freely oscillating wave or a relatively inexpensive microcomputer that is slower in operating speed. The number of freely oscillating waves counted should be set to about 2 to 10 and the number of times of the regression operation to about 5 to 10. When measurement accuracy is given priority, a relatively expensive coil can be used that is smaller in attenuation of a freely oscillating wave or a relatively expensive microcomputer that is higher in operation speed is used. The number of freely oscillating waves counted should be set to not less than 10 and the number of times of the regression operation not less than 10.

An action of amplifying the phase shift by the regression operation is described with reference to FIG. 12. Waveforms shown in FIG. 12 are output waveforms of the resonant circuit 2 when a regression operation is repeated 10 times. The regression operation outputs two shots of driving pulse signals in order to forcedly oscillate the resonant circuit 2 and newly outputs two other shots of driving pulse signals to the resonant circuit 2 at the time of counting the fifth freely oscillating wave that are attenuatedly output from the resonant circuit 2.

As shown in FIG. 12, the waveform at a top side illustrates a case when a metal is closer than a case illustrated by the waveform at a bottom side. Repeating a predetermined number of times the regression operation of outputting the driving signals to the resonant circuit 2 at the time of counting the predetermined number of freely oscillating waves amplifies the phase shift of freely oscillating waves. As a result, measurement accuracy of the phase shift involved in the proximity of the metal can be significantly improved only by increasing the number of times of the regression operation, without rendering the circuit configuration complicated. More specifically, with the use of a timer that starts clocking in response to the first output of driving signals by the driving signal outputting device and finishes clocking at the moment when the predetermined number of freely oscillating waves are output from the resonant circuit 2 after the predetermined number of times of the regression operation is ended, the phase shift that is involved in the proximity of the metal can be measured with high accuracy.

Next, a processing procedure in the one-chip microcomputer 3 is described with reference to FIG. 13. The one-chip microcomputer 3 firstly sets a reference voltage of a comparator (S11). After that, the one-chip microcomputer 3 repeats counter clearing processing (S12), driving signal outputting processing (S13: the driving signal outputting device), and phase shift measuring processing (S13 to S19: the phase shift measuring device).

As shown in FIG. 13, the counter clearing processing is processing of clearing a regression operation counter and a time measuring counter. The driving signal outputting processing is processing of outputting several shots of driving pulse signals at a predetermined resonant frequency with respect to the resonant circuit 2 such that an amplitude of a forcedly oscillating wave is maximized. The phase shift measuring processing clears a freely oscillating wave counter after the driving signals are stopped being output (S14). The phase shift measuring processing then counts the number of freely oscillating waves that are attenuatedly output from the resonant circuit 2 and also judges whether the counted number reaches a predetermined number (S15). When a result of the judgment is YES, the phase shift measuring processing increments the regression operation counter (S16) and judges whether the number of times of the regression operation reaches a predetermined number (S17). When a result of the judgment is NO, the phase shift measuring processing returns to the driving signal outputting processing and repeats S13 to S17. After the number of times of the regression operation reaches the predetermined number (S18: the time measuring device), the phase shift measuring processing reads in a value of the time measuring counter, transforms the read value of the time measuring counter into a predetermined detection signal format (a proximity distance signal, for example), and outputs the transformed read value of the time measuring counter (S19).

The proximity sensor 1 of the second embodiment configured as above includes a resonant circuit 2 that includes a capacitor C connected to a detecting coil L, a driving signal outputting device that outputs a driving signal to the resonant circuit 2, and a phase shift measuring device that measures a phase shift of oscillating waves that is involved in the proximity of the metal based on freely oscillating waves that are attenuatedly output from the resonant circuit 2 after the driving signal outputting device stops its signal output.

The phase shift measuring device repeats a predetermined number of times the regression operation of counting the number of freely oscillating waves that are output from the resonant circuit 2 after the driving signal outputting device stops its signal output and making the driving signal outputting device output a driving signal at the time of counting a predetermined number of freely oscillating waves. By this device, the phase shift of the freely oscillating waves is amplified so that the phase shift of oscillating waves that is involved in the proximity of the metal can be measured accurately with a simple circuit configuration. More specifically, as for the freely oscillating waves that are attenuatedly output from the resonant circuit 2, the phase shift of oscillating waves that is involved in the proximity of the metal not only clearly occurs but also is accumulated by the number of oscillating waves. Therefore, the phase shift can be measured with high accuracy even by an inexpensive digital circuit that does not have a high speed counter. Moreover, the phase shift of freely oscillating waves is amplified by repeating a predetermined number of times the regression operation of outputting a driving signal to the resonant circuit 2 at the time of counting a predetermined number of freely oscillating waves. Accordingly, measurement accuracy of the phase shift that is involved in the proximity of the metal can be significantly improved only by increasing the number of times of the regression operation, without rendering the circuit configuration complicated.

The phase shift measuring device includes a time measuring device that starts clocking in response to the first output of driving signals by the driving signal outputting device and, after the predetermined number of times of the regression operation is finished, finishes clocking at the moment when a predetermined number of freely oscillating waves is output from the resonant circuit 2. Consequently, the amplified phase shift can be measured with high accuracy by an inexpensive digital circuit.

The present disclosure can be applied to a proximity sensor such as a proximity switch that is used as a non-contact micro switch, a displacement sensor that detects a displacement of a metal, a distance sensor that detects a proximity distance to a metal, a material sensor that determines a material of a metal, a coin sensor that detects a passage of a coin (hard currency, a token and the like), and a metallic sphere sensor that detects a penetration of a metallic sphere (a pachinko ball and the like), and to a proximity detecting method. In particular, the present disclosure can be suitably used for a high-precision displacement sensor for detecting a displacement of a metal with high accuracy.

1. A proximity sensor for detecting proximity of a metal, wherein a driving signal is output to a resonant circuit that includes a capacitor connected to a detecting coil, and the proximity of the metal is detected based on a phase shift of freely oscillating waves that are attenuatedly output from the resonant circuit after an output of the driving signal is stopped, the proximity sensor comprising:
a controller that:
outputs the driving signal to the resonant circuit; and
measures a phase shift of oscillating waves that is involved in the proximity of the metal based on the freely oscillating waves that are attenuatedly output from the resonant circuit after the output of the driving signal is stopped.

2. (canceled)

3. The proximity sensor according to claim 1, wherein the controller:
counts a number of the freely oscillating waves that are attenuatedly output from the resonant circuit after the output of the driving signal is stopped; and
counts a time until a predetermined number of the freely oscillating waves are counted.

4. The proximity sensor according to claim 1, wherein the controller:
repeats a predetermined number of times a regression operation of counting a number of the freely oscillating waves that are output from the resonant circuit after the output of the driving signal is stopped, and outputting the driving signal at a time of counting a predetermined number of the freely oscillating waves, so that the phase shift of the freely oscillating waves is amplified.

5. The proximity sensor according to claim 1, wherein the controller:
repeats a predetermined number of times a regression operation of counting a number of the freely oscillating waves that are output from the resonant circuit after the output of the driving signal is stopped, and outputting the driving signal at a time of counting the predetermined number of the freely oscillating waves, so that the phase shift of the freely oscillating waves is amplified;
starts clocking in response to a first output of the driving signal; and
finishes clocking when a predetermined number of the freely oscillating waves is output from the resonant circuit after the regression operation is finished the predetermined number of times.

6-11. (canceled)

12. A proximity detecting method for detecting proximity of a metal, the proximity detecting method comprising:
outputting a driving signal to a resonant circuit that includes a capacitor connected to a detecting coil; and
detecting the proximity of the metal based on a phase shift of freely oscillating waves that are attenuatedly output from the resonant circuit after the output of the driving signal is stopped.

13. The proximity detecting method according to claim 12, further comprising the steps of:
outputting the driving signal to the resonant circuit;
counting a number of the freely oscillating waves that are attenuatedly output from the resonant circuit after the output of the driving signal is stopped;
measuring a time until a predetermined number of the freely oscillating waves is counted; and
measuring the phase shift of the oscillating waves that is involved in the proximity of the metal based on the measured time.

14. A proximity detecting method for detecting proximity of the metal, the proximity detecting method comprising:
outputting a driving signal to a resonant circuit that includes a capacitor connected to a detecting coil;
measuring a phase shift of oscillating waves that is involved in the proximity of the metal based on freely oscillating waves that are attenuatedly output from the resonant circuit after the output of the driving signal is stopped; and
repeating a predetermined number of times a regression operation of counting a number of the freely oscillating waves that are output from the resonant circuit after the output of the driving signal is stopped, and outputting the driving signal to the resonant circuit at a time of counting a predetermined number of the freely oscillating waves, so that the phase shift of the freely oscillating waves is amplified.

15. The proximity detecting method according to claim 14, further comprising the steps of:
starting clocking in response to a first output of the driving signal to the resonant circuit;
finishing clocking when the predetermined number of the freely oscillating waves is output from the resonant circuit after the regression operation is finished the predetermined number of times; and
measuring the phase shift of the oscillating waves that is involved in the proximity of the metal based on a result of the clocking.

16-18. (canceled)

19. The proximity sensor according to claim 1, wherein the detecting coil is also used as an exciting coil.

20. The proximity detecting method according to claim 12, wherein the detecting coil is also used as an exciting coil.

21. The proximity detecting method according to claim 14, wherein the detecting coil is also used as an exciting coil.

22. The proximity sensor according to claim 3, wherein the number of the freely oscillating waves is set to about 2 to 100.

23. The proximity detecting method according to claim 13, wherein the number of the freely oscillating waves is set to about 2 to 100.

24. The proximity detecting method according to claim 14, wherein the number of the freely oscillating waves is set to about 2 to 100.

25. The proximity sensor according to claim 1, wherein resonant circuit is a series resonant circuit where the capacitor is serially connected to the detecting coil.

26. The proximity detecting method according to claim 12, wherein resonant circuit is a series resonant circuit where the capacitor is serially connected to the detecting coil.

27. The proximity detecting method according to claim 14, wherein resonant circuit is a series resonant circuit where the capacitor is serially connected to the detecting coil.
